(19) United States
(12) Patent Application Publication
(10) Pub. No.: US 2012/0241111 A1
(43) Pub. Date: Sep. 27, 2012

(54) MECHANISM FOR CONTROLLING THE ROTATION OF A ROLLER BLIND WINDING ROLLER HAVING A SPRING DRIVE

(76) Inventor: Jerzy Wolek, (US)

(21) Appl. No.: 13/456,952

(22) Filed: Apr. 26, 2012

(30) Foreign Application Priority Data
Mar. 7, 2010 (PL) P-390633
Nov. 8, 2010 (PL) PCT/PL2010/000114

(51) Int. Cl. E06B 9/56

(52) U.S. Cl. 160/299

(57) ABSTRACT

One embodiment of a mechanism for controlling the rotation of a roller blind winding roller having a spring drive and immovably fixed to a roller blind holder and its winding roller is constructed of an outer roller (1), on which a sleeve (2) is seated. In the sleeve (2) there is rotationally seated an inner roller (4), and between the sleeve (2) and the inner roller (4) there is an annular slot filled with a breaking layer (5) formed from high viscosity medium. The inner roller (4) contains a formed driver (6) and in the sleeve (2), between the inner roller (4) and the outer roller (1) there is a break shoe (3) seated with its pin (9) in the opening (7) of the outer roller (1), and a relief (8) where the driver (6) of the inner roller (4) is seated.

### CROSS REFERENCE TO RELATED APPLICATIONS

This application claims priority from PCT Application No. PCT/PL2010/000114, filed 8 Nov. 2010 which claims priority from Polish National Application No. P-390633, filed 7 Mar. 2010. The entire, specification, claims and drawings of PCT Application No. PCT/PL2010/000114 are hereby incorporated herein by reference.

### BACKGROUND OF THE INVENTION

(1) Field of the Invention.

The present invention relates to the field of The subject of invention is a mechanism controlling the rotation of roller blinds winding roller with a spring drive, especially a window blinds, when rolling or unrolling the sunshade.

(2) Description of the related art

There are known restraining devices containing a decelerating structure, connected with roller blinds having spring drive. These are generally described as toothed planetary gear units with a central wheel, planet wheels and ring gear. A rotor is joined with the central wheel and planet wheels are rotationally seated on a unidirectional coupling, while the ring gear is rotationally joined with a roller, hollowed along its entire length, the two ends of which are rotationally joined with a couple of bearing pivots. The edge of the sunshade is attached to the roller, and inside the roller there is an immobile middle rod, joined to one of the bearing pivots. A spring, functionally adjusted to impart rotation of the roller in a first direction round its axis with pull on the sunshade, is joined with the middle rod and with the roller. In the roller there is located a fluid brake, functionally connected with the roller and middle rod, restraining rotation of the roller in its first direction. A chamber of the liquid brake is rotationally joined with the roller.

The problem with these known restraining devices is that their endurance is low.

Development of a restraining device with higher endurance represents a great improvement in the field of roller binds and satisfies a long felt need of the roller blind customers.

### SUMMARY OF THE INVENTION

The present invention is a mechanism for controlling the rotation of a roller blind winding roller with a spring drive, immovably fixed to a roller blind holder. The winding roller is made of a pipe inside which an inner roller is seated on which a sleeve is seated. In the sleeve there is an inner roller seated rotationally, and between the roller and the sleeve there is an annular slot filled with a breaking layer formed of high viscosity medium. The inner roller contains a driver and in the sleeve, between the inner and outer roller there is a brake shoe seated with its pin in the outer roller's opening and a relief where the inner roller's driver is seated.

Alternatively, the outer roller has a pin, the brake shoe has an opening, and the outer roller's pin is seated in the opening of the brake shoe.

The second example of performance of this invention is an outer roller on which a sleeve is seated. An inner roller is seated rotationally in the sleeve, and between the inner roller and the sleeve there is an annular slot filled with a braking layer formed from high viscosity medium. The inner roller contains a formed driver and in the sleeve, between the inner and outer rollers there is a brake shoe seated with a pin in the outer roller's opening, and has a driver which co-operates with the inner roller's driver.

Alternatively, the outer roller has a pin, the brake shoe has an opening, and the outer roller's pin is seated in the opening of the brake shoe.

The third example of performance of this invention is an outer roller on which a sleeve is seated. An inner roller is seated rotationally in the sleeve. Between the inner roller and the sleeve there is an annular slot filled with a braking layer formed from high viscosity medium. The inner roller contains a formed relief and in the sleeve, between the inner and outer rollers there is a brake shoe seated with a pin in the outer roller's opening, and a driver which co-operates with the inner roller's relief.

Alternatively, the outer roller has a pin, the brake shoe has an opening, and the outer roller's pin is seated in the opening of the brake shoe.

The fourth example of performance of this invention is an outer roller on which a sleeve is seated. In the sleeve there is rotationally seated an inner roller, and between the inner roller and the sleeve there is an annular slot filled with a braking layer formed from high viscosity medium. The inner roller contains a pin and in the sleeve, between the inner and outer rollers there is a brake shoe with a pin seated in the outer roller's opening, and a brake shoe has an opening in which the inner roller's pin is inserted.

Alternatively, the outer roller has a pin, the brake shoe has an opening, and the outer roller's pin is seated in the opening of the brake shoe.

The fifth example of performance of this invention is an outer roller on which a sleeve is seated. In the sleeve there is rotationally seated an inner roller, and between the sleeve and the inner roller there is an annular slot filled with a braking layer formed from high viscosity medium. The inner roller contains an opening and in the sleeve, between the inner roller and the outer roller there is a brake shoe seated with its pin in the outer roller's opening, and having a pin which co-operates with the inner roller's opening.

Alternatively, the outer roller has a pin, the brake shoe has an opening, and the outer roller's pin is seated in the opening of the brake shoe.

The solution applied in this invention ensures several times higher endurance of the mechanism in comparison to known designs.

The remaining aims and objectives of this invention and the rule of its operation have been presented on the drawings with the detailed description of a preferred embodiment.

### BRIEF DESCRIPTION OF THE DRAWINGS

FIG. 1 is a view from one end of this invention.

FIG. 1A is a cross section along the lines 1A-1A (in other words a longitudinal cross section) of FIG. 1 showing a first embodiment of this invention.

FIG. 1B is a cross section along the lines 1B-1B of FIG. 1A; in other words a lateral cross section of the invention.

FIG. 1C is a partial cross section showing a first variation applicable to all embodiments of this invention.

FIG. 1D is a partial cross section showing a second variation applicable to all embodiments of this invention.

FIG. 2A is a cross section along the lines 1A-1A of Figure (in other words a longitudinal cross section) 1 showing a second embodiment of this invention.

FIG. 2B is a cross section along the lines 2B-2B of FIG. 2A; in other words a longitudinal cross section at 90 degrees from the plane of cross section shown in FIG. 2A.

FIG. 2C is an enlarged, partial view of FIG. 2B.

FIG. 2D is a cross section along the lines 2D-2D of FIG. 2C; in other words a lateral cross section of the invention.

FIG. 3A is a cross section along the lines 1A-1A of FIG. 1 (in other words a longitudinal cross section) showing a third embodiment of this invention.

FIG. 3B is a cross section along the lines 3B-3B of FIG. 3A; in other words a longitudinal cross section at 90 degrees from the plane of cross section shown in FIG. 3A.

FIG. 4 is a cross section along the lines 1A-1A of FIG. 1 (in other words a longitudinal cross section) showing a fourth embodiment of this invention.

FIG. 5A is a cross section along the lines 1A-1A of FIG. 1 (in other words a longitudinal cross section) showing a fifth embodiment of this invention.

FIG. 5B is a cross section along the lines 5B-5B of FIG. 5A; in other words a longitudinal cross section at 90 degrees from the plane of cross section shown in FIG. 5A.

FIG. 6A is a cross section along the lines 1A-1A of FIG. 1 (in other words a longitudinal cross section) showing a first variation of the fifth embodiment of this invention.

FIG. 6B is a cross section along the lines 6B-6B of FIG. 6A; in other words a longitudinal cross section at 90 degrees from the plane of cross section shown in FIG. 6A.

FIG. 7A is a detail of the end of the outer roller

FIG. 7B is an end view of the outer roller

FIG. 8A is a view from one end of the brake shoe

FIG. 8B is a view from one side of the brake shoe

FIG. 8C is a view from the other end of the brake shoe

FIG. 9A is a view from the inner end of the inner roller

FIG. 9B is a side view of the inner roller

### DETAILED DESCRIPTION OF THE PREFERRED EMBODIMENT

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

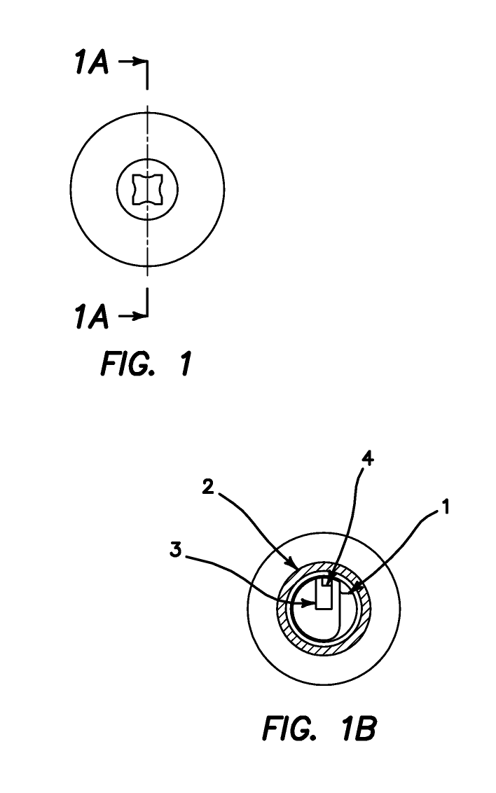

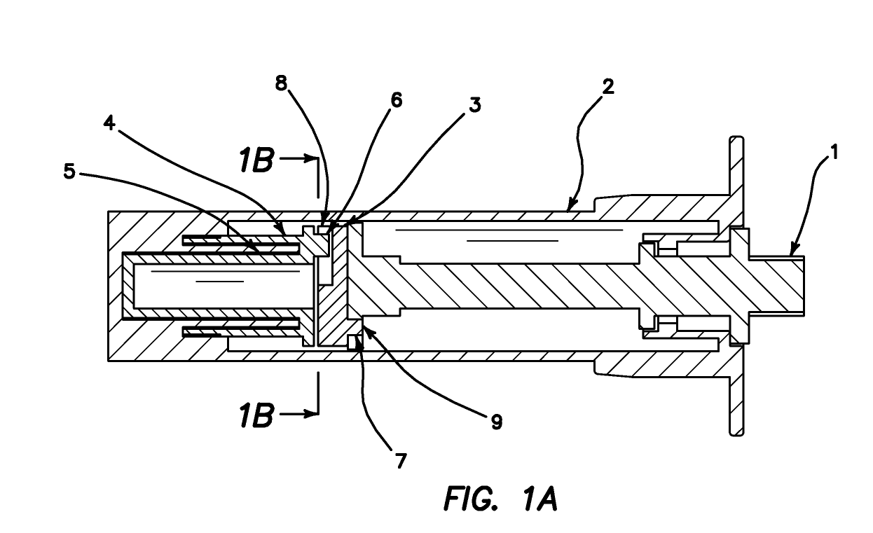

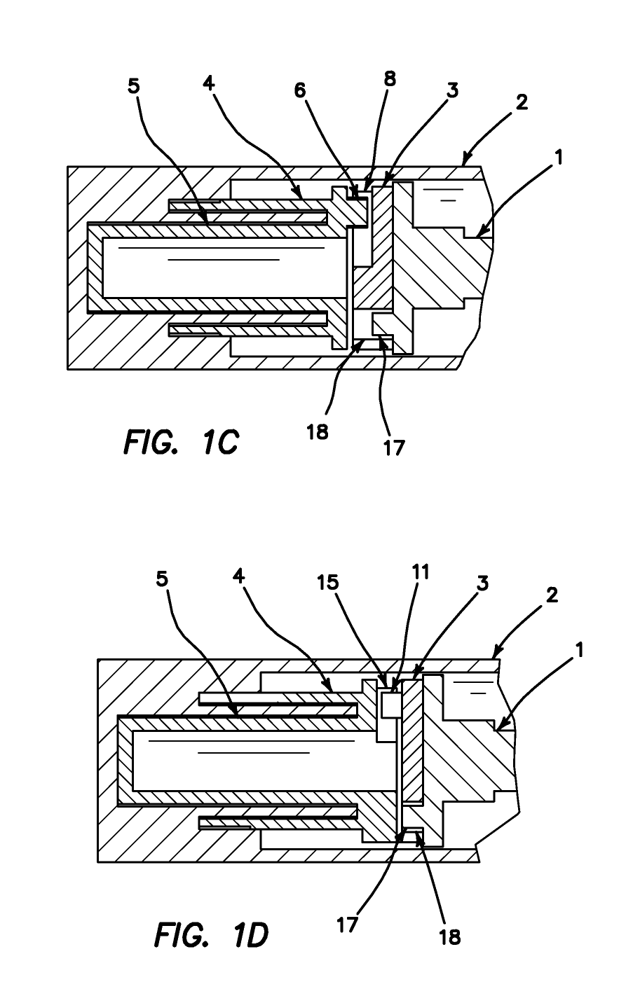

As shown in FIGS. 1, 1A, and 1B, a first embodiment of this invention is made up of an outer roller 1, on which a sleeve 2 is seated. In the sleeve 2 there is rotationally seated an inner roller 4, and between the sleeve 2 and the roller 4 there is an annular slot 5 filled with a high viscosity medium. The inner roller 4 includes a formed driver 6. Between the inner roller 4 and outer roller 1 there is a brake shoe 3 seated with its pin 9 in the opening 7 of the outer roller 1. The brake shoe 3 has a relief 8 in which the driver 6 of the inner roller 4 is seated.

Alternatively, as shown in FIGS. 1C, the outer roller 1 has no opening 7 but has a pin 17, the brake shoe 3 has no pin 9 but has an opening 18, and the brake shoe 3 is seated with its opening 18 on the pin 17 of the outer roller 1.

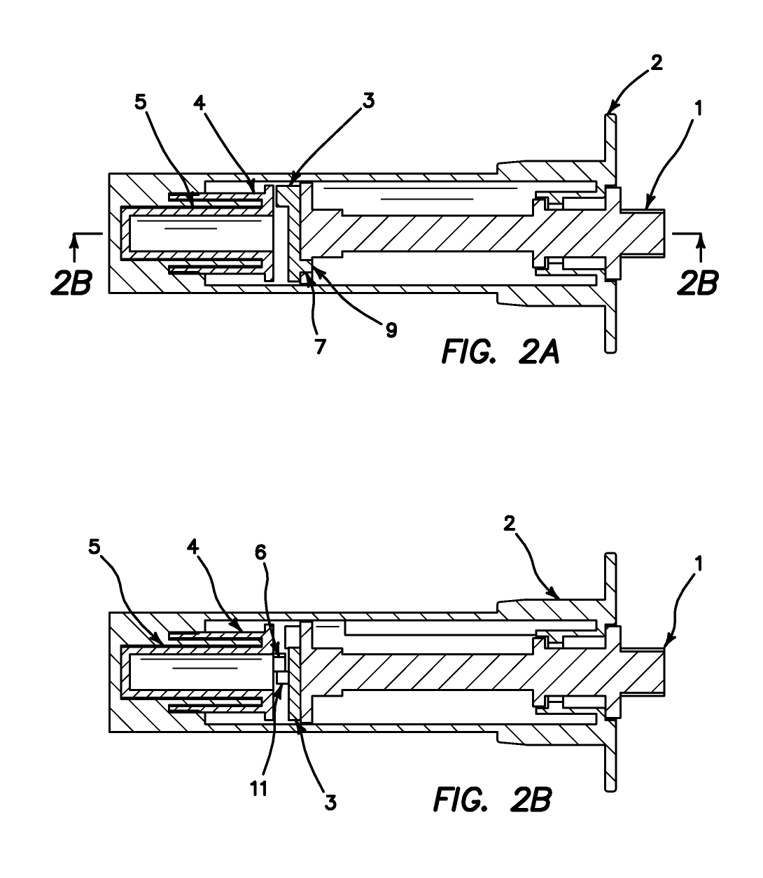

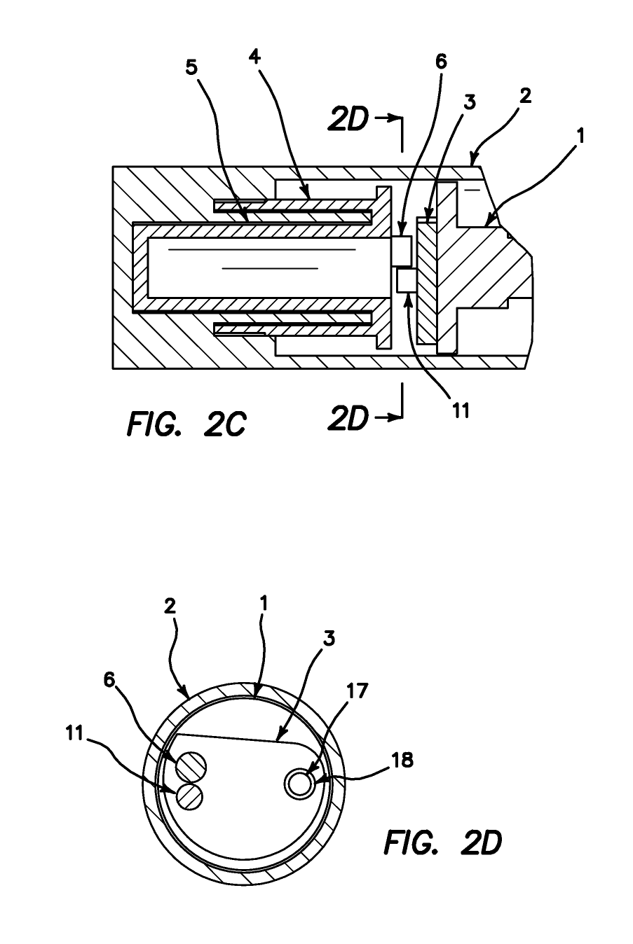

As shown on FIGS. 2A, 2B, 2C and 2D, a second embodiment of this invention is an outer roller 1 on which a sleeve 2 is seated. In the sleeve 2 there is rotationally seated an inner roller 4, and between the sleeve 2 and the inner roller 4 there is an annular slot 5 filled with a high viscosity medium. The inner roller 4 contains a formed driver 6. In the sleeve 2, between the inner roller 4 and the outer roller 1 there is a brake shoe 3 seated with its pin 9 in opening 7 of the outer roller 1, and also having a driver 11 which co-operates with the driver 6 of the inner roller 4.

Alternatively, the outer roller 1 has no opening 7 but has a pin 17, brake shoe 3 has no pin 9 but has an opening 18 and the brake shoe 3 is seated with is opening 18 on the roller's 1 pin 17, similar to what is shown in FIG. 1C.

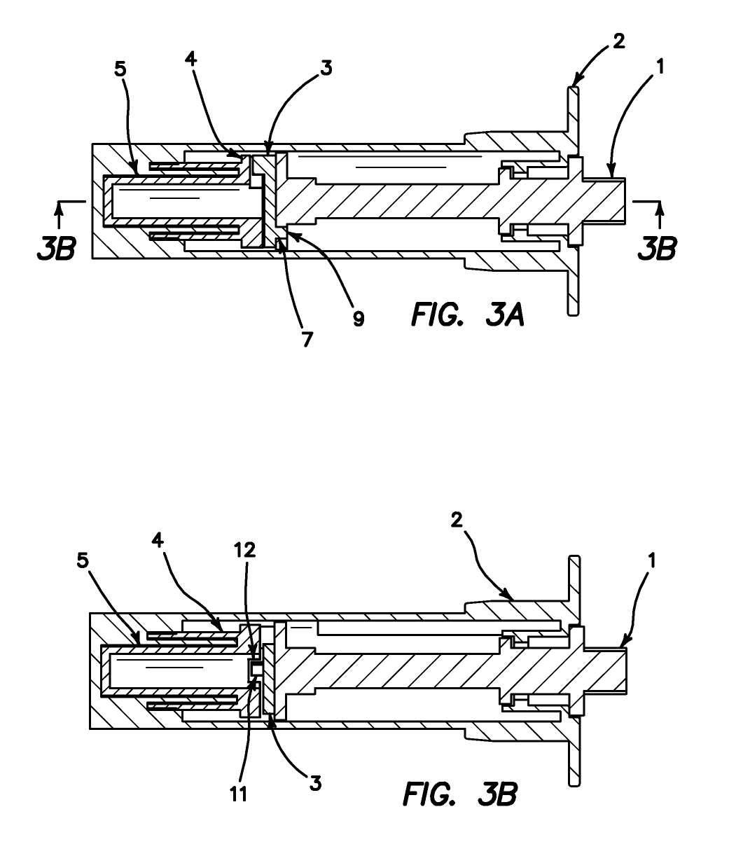

As shown on FIGS. 3A and 3B, a third embodiment is made up of an outer roller 1 on which a sleeve 2 is seated. In the sleeve 2 there is rotationally seated an inner roller 4, and between the sleeve 2 and the inner roller 4 there is an annular slot filled with braking layer 5 formed from high viscosity medium. The inner roller 4 contains a formed relief 12 and in the sleeve 2, between the inner roller 4 and the outer roller 1 there is a brake shoe 3 seated with its pin 9 in the opening 7 of the outer roller 1, having a driver 11 which co-operates with the relief 12 of the inner roller 4.

Alternatively, the outer roller 1 has no opening 7 but has a pin 17, the brake shoe 3 has an opening 18 and the brake shoe 3 is seated with its opening 18 on the pin 17 of the outer roller 1, similar to what is shown in FIG. 1C.

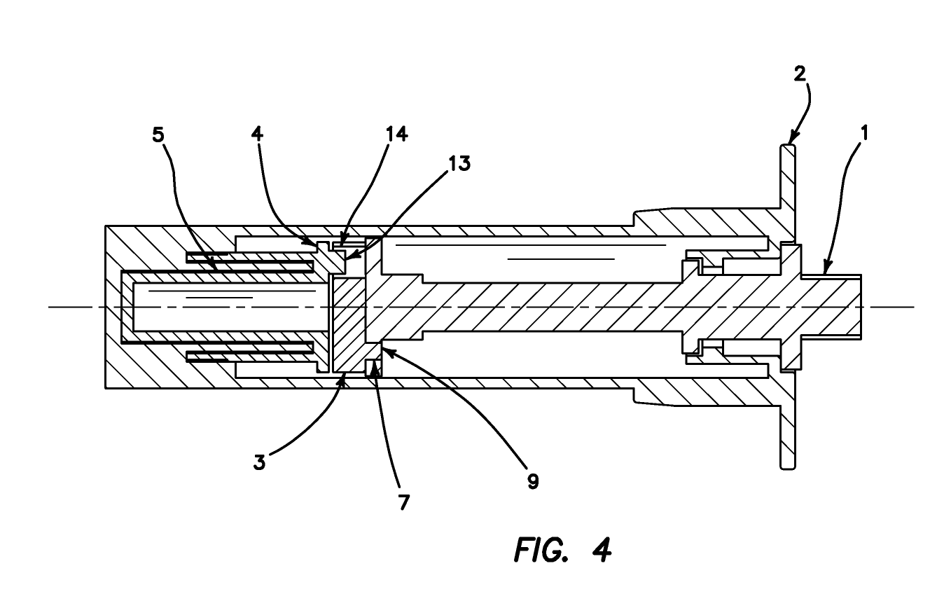

As shown on FIG. 4, a fourth embodiment of this invention is made up of an outer roller 1 on which a sleeve 2 is seated. In the sleeve 2 there is rotationally seated an inner roller 4, and between the sleeve 2 and the inner roller 4 there is an annular slot filled with braking layer 5 formed from high viscosity medium. The inner roller 4 has a pin 13 and in the sleeve 2, between the inner roller 4 and the outer roller 1 there is a brake shoe 3 seated with its pin 9 in the opening 7 of outer roller 1, having an opening 14 in which pin 13 of the inner roller 4 is inserted.

Alternatively, the outer roller 1 has a pin 17, the brake shoe 3 has an opening 18, and the brake shoe 3 is seated with its opening 18 on the pin 17 of the outer roller 1, similar to what is shown in FIG. 1C.

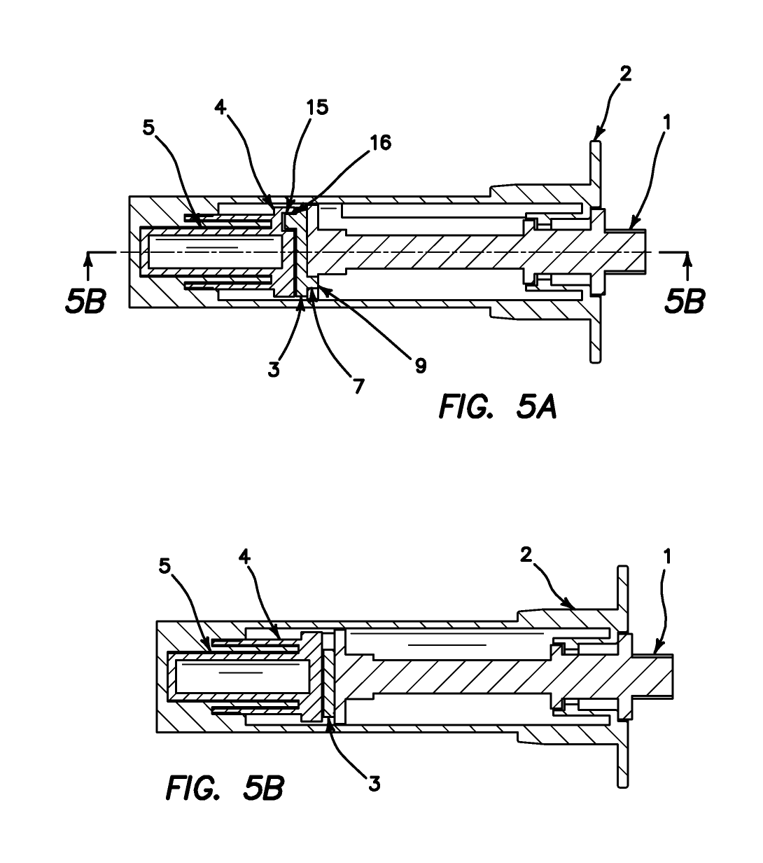

As shown on FIGS. 5A and 5B, a fifth embodiment is made up of an outer roller 1 on which a sleeve 2 is seated. In the sleeve 2 there is rotationally seated an inner roller 4, and between the sleeve 2 and the roller 4 there is an annular slot filled with braking layer 5 formed from high viscosity medium. The inner roller 4 contains an opening 15 and in the sleeve 2, between the inner roller 4 and the outer roller 1 there is a brake shoe 3 seated with its pin 9 in the opening 7 of the outer roller 1, having a pin 16 which co-operates with the opening 15 of the inner roller 4.

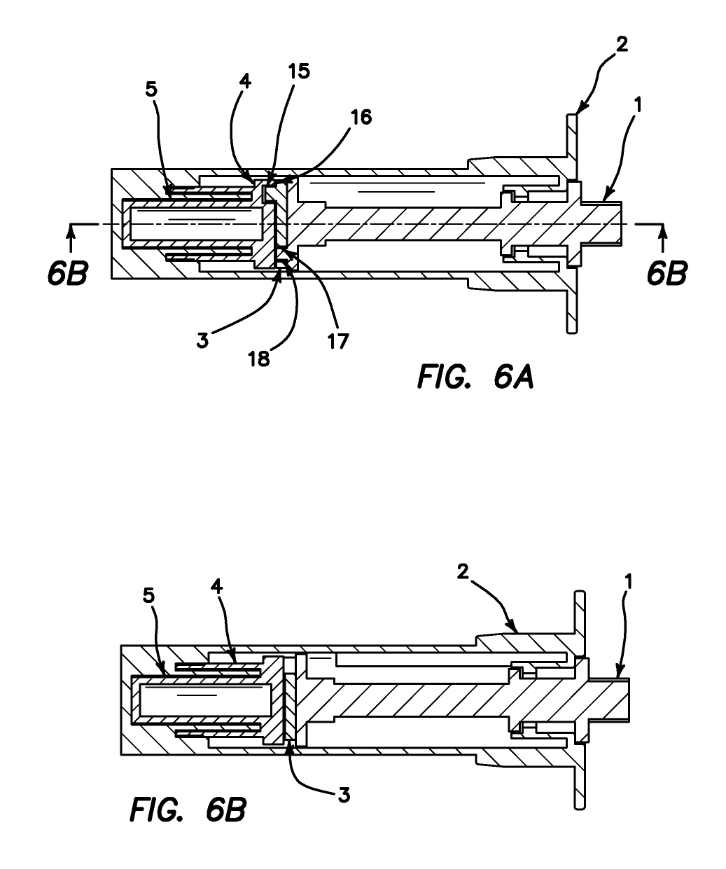

Alternatively, as shown on FIGS. 6A and 6B, the outer roller 1 has no opening 7 but has a pin 17, the brake shoe 3 has no pin 9 but has an opening 18 and the brake shoe 3 is seated with its opening 18 on the roller's 1 pin 17.

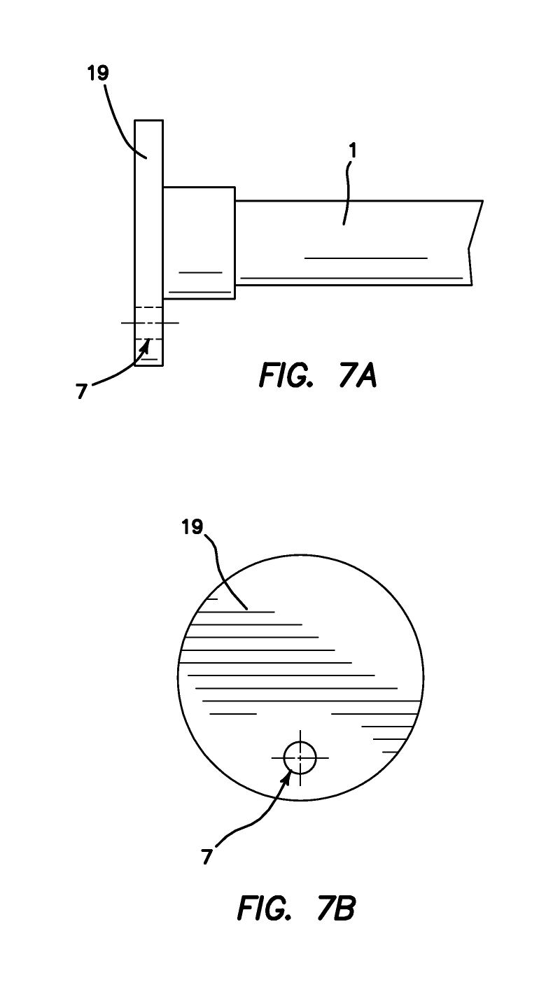

FIGS. 7A and 7B show further details of construction for the outer roller 1.

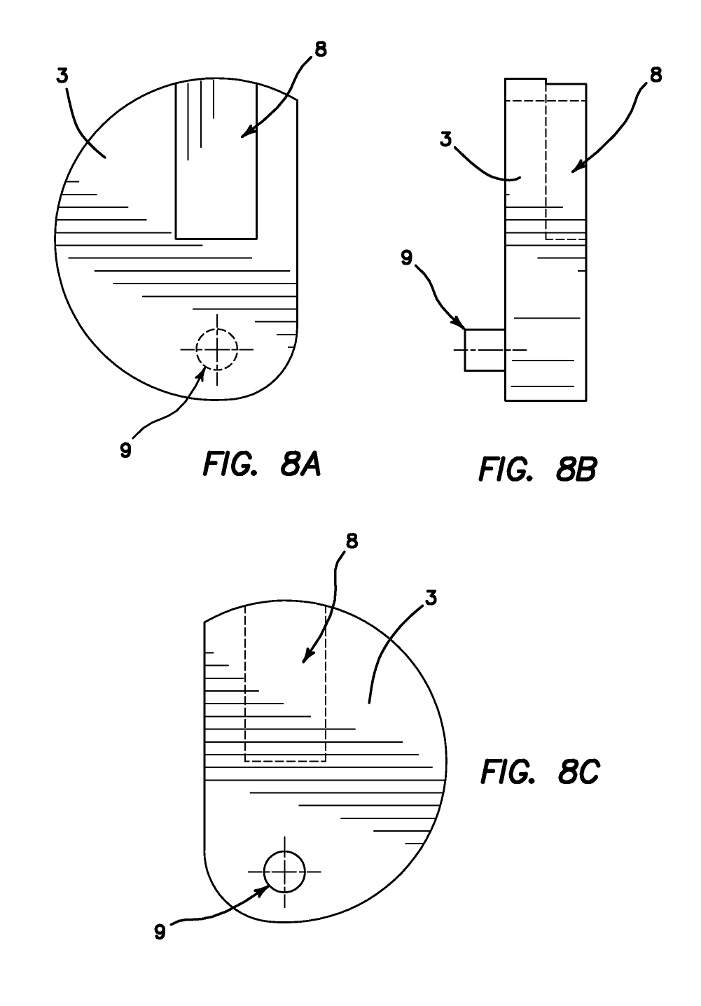

FIGS. 8A, 8B and 8C show further details of construction of the brake shoe 3.

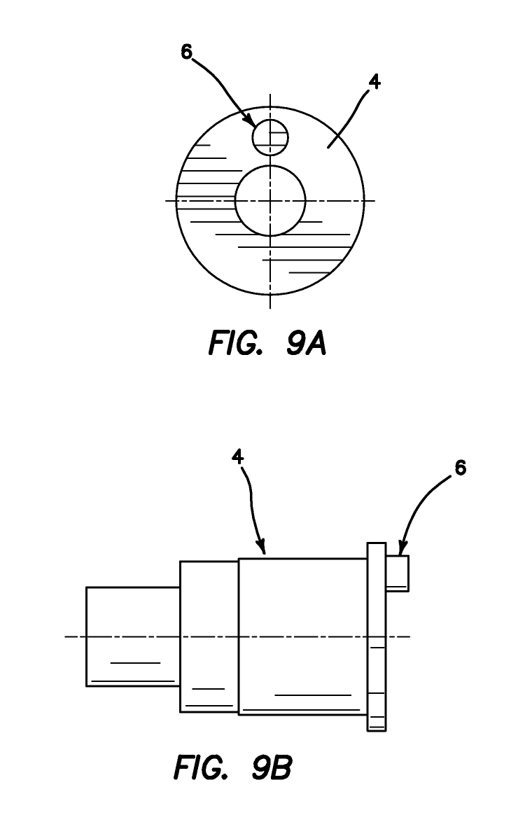

FIGS. 9A and 9B show further details of construction of the inner roller 4.

In each embodiment a torsion spring 20 is mounted inside the winding roller with one end immovably fixed to a roller blind holder that is fixed to a wall or a ceiling and with the other end to a winding roller of the roller blind. The mechanism is immovably fixed to a winding roller with a sleeve 2 and with its outer roller 1 it is immovably fixed to a roller blind holder that is fixed to a wall or a ceiling. The spring 20 is mounted with some preliminary torsion depending on the size and weight of roller blind and desired winding speed. The greater the torsion in the spring, the greater the winding speed. When the roller blind is pulled down by hand, torsion increases. When it is desired to roll up the blind, spring tension makes the roller 1 rotate thus winding up the blind.

After installing the roller blind to a wall or ceiling the blind can be unwound to a desired length by pulling the bottom edge of the blind. As the blind is pulled down torsion in the spring 20 increases. After the blind is pulled to desired length the bottom edge gets released and, thanks to a ratchet mechanism, which is not a subject of this application, the blind remains unwound. To make the roller blind wind up again the lower edge is gently pulled down and let free. The ratchet mechanism releases the roller allowing it to wind up. Thanks to controlling mechanism of this invention, the roller blind wind up evenly until it reaches the upper position or is pulled once again downwards. Without the controlling mechanism constituting this invention, roller blinds would wind up at a very high, uncontrolled speed which might damage the mechanism and the roller blinds themselves.

The high viscosity medium is non-volatile, non-toxic, and has an average viscosity of 6000 to 26000 mPa·s over a wide temperature range. The principle of its action is as follows.

Sleeve 2 is seated inside the winding roller pipe. Winding up roller blinds by the torsion spring mounted inside the winding roller through the sleeve 2 and the braking layer 5 formed of high viscosity medium, the roller 4 rotates the brake shoe 3 seated with the pin 9 in the opening 7 of the roller 1 until contact between the side surface of the brake shoe and the inner surface of the sleeve 2 is reached. After contact with the brake shoe and the sleeve, the roller 4 presses the brakes shoe 3 down to the surface of the sleeve 2, thereby increasing the friction between the sleeve 2 and 3 of the brake shoe which reduces the winding speed of the roller blinds. With the increase of winding speed of the roller blinds the rotating speed of the sleeve 2 increases, thus increasing the force transmitted through the braking layer 5 and the roller 4 on the brake shoe 3 and thus the roller blinds release. Reducing the speed lowers the power transferred to the brake shoe 3 and thus increasing winding speed of the roller blinds. The solution applying only braking layer 5 between the inner roller 4 and the sleeve 2does not ensure satisfactory results because of decrease of the acting braking power generated by the braking layer. This is also the case when the temperature increases. Application of the brake shoe 3 eliminates effect of reducing the force generated by the braking layer 5, which allows the use of the mechanism at different temperatures and for all types of roller blinds with the torsion spring, regardless of their weight.

The following reference numbers are used on FIGS. 1 through 9B:

1 outer roller

2 sleeve

3 brake shoe

4 inner roller

5 annular slot

6 formed driver

7 opening

8 relief

9 pin

11 driver

12 formed relief

15 opening

16 pin

17 pin

18 opening

19 end flange of outer roller

20 torsion spring

Thus, the present invention has been described herein with reference to a particular embodiment for a particular application. Those having ordinary skill in the art and access to the present teachings will recognize additional modifications, applications and embodiments within the scope thereof

It is therefore intended by the appended claims to cover any and all such applications, modifications and embodiments within the scope of the present invention.

What is claimed is:

1. A mechanism for controlling the rotation of a roller blind winding roller comprising:
a) an outer roller (1);
b) a sleeve (2) seated on said outer roller (1);
c) an inner roller (4) rotationally seated in said sleeve (2); said inner roller (4) including a formed driver (6) in said sleeve (2), between inner roller (4) and said outer roller (1);
d) a breaking layer (5) filling an annular slot between said sleeve (2) and said inner roller (4); and
e) a break shoe (3) between said outer roller (1) and inner roller (4) having a relief (8) in which said driver (6) is seated.

2. A mechanism according to claim 1 in which said outer roller (1) has an opening and said brake shoe (3) has a pin (9) seated in said opening (7).

3. A mechanism according to claim 1 in which said brake shoe (3) has an opening (18) and said outer roller (1) has a pin (17) seated in said opening (18).

4. A mechanism for controlling the rotation of a roller blind winding roller comprising:
a) an outer roller (1);
b) a sleeve (2) seated on said outer roller (1);
c) an inner roller (4) rotationally seated in said sleeve (2); said inner roller (4) including a formed driver (6) in said sleeve (2), between inner roller (4) and said outer roller (1);
d) a breaking layer (5) filling an annular slot between said sleeve (2) and said inner roller (4); and
e) a break shoe (3) in said sleeve (2) between said outer roller (1) and inner roller (4) having a driver (11) which co-operates with said formed driver (6).

5. A mechanism according to claim 4 in which said brake shoe (3) has an opening (18) and said outer roller (1) has a pin (17) seated in said opening (18).

6. A mechanism for controlling the rotation of a roller blind winding roller comprising:
a) an outer roller (1);
b) a sleeve (2) seated on said outer roller (1);
c) an inner roller (4) rotationally seated in said sleeve (2); said inner roller (4) including a relief (12) in said sleeve (2), between said inner roller (4) and said outer roller (1);
d) a breaking layer (5) filling an annular slot between said sleeve (2) and said inner roller (4); and
e) a break shoe (3) between said outer roller (1) and inner roller (4) having a driver (11) co-operating with said relief (12).

7. A mechanism according to claim 6 in which said brake shoe (3) has an opening (18) and said outer roller (1) has a pin (17) seated in said opening (18).

8. A mechanism for controlling the rotation of a roller blind winding roller comprising:
a) an outer roller (1) having an opening (7);
b) a sleeve (2) seated on said outer roller (1);
c) an inner roller (4) rotationally seated in said sleeve (2); said inner roller (4) including a pin (13) in said sleeve (2), between said inner roller (4) and said outer roller (1);
d) a breaking layer (5) filling an annular slot between said sleeve (2) and said inner roller (4); and
e) a break shoe (3) between said outer roller (1) and said inner roller (4), having a pin (9), in said opening (7) and an opening (14) in which said pin (13) is inserted.

9. A mechanism according to claim 8 in which said brake shoe (3) has an opening (18) and said outer roller (1) has a pin (17) seated in said opening (18).

10. A mechanism for controlling the rotation of a roller blind winding roller comprising:
a) an outer roller (1) having an opening (7);
b) a sleeve (2) seated on said outer roller (1);
c) an inner roller (4) rotationally seated in said sleeve (2); said inner roller (4) including an opening (15) in said sleeve (2), between said inner roller (4) and said outer roller (1);
d) a breaking layer (5) filling an annular slot between said sleeve (2) and said inner roller (4); and
e) a break shoe (3) between said outer roller (1) and said inner roller (4), having a pin (9), in said opening (7) and a pin (16), which co-operates with said opening (15).

11. A mechanism according to claim 10 in which said brake shoe (3) has an opening (18) and said outer roller (1) has a pin (17) seated in said opening (18).
